(19) United States
(12) Patent Application Publication
(10) Pub. No.: US 2003/0130875 A1
(43) Pub. Date: Jul. 10, 2003

(54) Real-time prescription renewal transaction across a network

(76) Inventors: Maher M. Hawash, Hillsboro, OR (US); Rohan Coelho, Portland, OR (US); Karl Allen, Portland, OR (US); Michael J. Payne, Beaverton, OR (US)

Correspondence Address: James H. Salter, BLAKELY, SOKOLOFF, TAYLOR & ZAFMAN LLP, Seventh Floor, 12400 Wilshire Boulevard, Los Angeles, CA, 90025-1026, US

(21) Appl. No.: 10/039,120

(22) Filed: Jan. 4, 2002

(51) Int. Cl. G06F 17/60

(52) U.S. Cl. 705/3

(57) ABSTRACT

The present invention provides for performing a prescription renewal transaction through a portable healthcare device, including providing prescription-related information with a request for renewal of the prescription. A renewal request is transmitted from a pharmacy site to a benefits manager, where the relevant prescription-related information is immediately added. The request is prepared by an access server for reading at the portable healthcare device and is considered by the healthcare professional in generating a decision to allow or disallow the renewal. This response is returned into an end-to-end communication system that includes a real-time communication channel to the remote prescription site. In addition, other aspects of the present invention relating to the renewal of a prescription.

### FIELD OF THE INVENTION

The present invention relates generally to conducting electronic prescription renewal transactions in real-time. In particular, this invention is related to a communication of a pharmacy site, a remote healthcare benefits manager, such as a Pharmacy Benefit Manager (PBM) and a portable healthcare device, across a network for transacting a renewal of a prescription.

### BACKGROUND

There are growing uses for handheld devices in conducting prescription-related transactions that involve exchanges of electronic information across a network. Health professionals, such as physicians, medical staff, dentists, pharmacists, health plan administrators, public health officials, etc. may use handheld devices in performing their daily workflow.

One particular task is electronic prescription service, referred to as “e-prescribing”, and is usually performed by submitting online claims to remote payers and electronically routing orders to pharmacies, including retail, online or mail order pharmacies. E-prescribing enables a healthcare professional to write, order and renew prescriptions and to review information related to selected prescription items.

Renewal of prescriptions occurs where a patient desires to obtain a refill on a previous prescription and the prescription does not authorize such a refill, e.g. the prescription does not permit any refills, all prescribed refills have been already used by the patient or the prescribed refill time is expired. In this case, the pharmacy asks a healthcare professional who is responsible for the prescription, e.g. a physician, to authorize the pharmacy to supply a refill. The healthcare professional must approve additional the refill(s) before a new dosage is dispensed to the patient. As shown in FIG. 1A, typically the pharmacy site 16 directly communicates, such as via the telephone, with the healthcare professional 70.

In addition, a pharmacy may also contact a remote benefits manager 40, such as a PBM, for adjudication of the renewal to determine whether such renewal is within permissible grounds, e.g. in compliance with a pre-established formulary for a patient so that the benefits manager may manage the process of health insurance companies paying for prescriptions. The benefits manager often has recent prescription-related information regarding specific patients, such as patient prescription history, formularies for the patient, and other such prescription-related information applicable to prescription program administration and retained at the benefits manager.

Oftentimes, the request for renewal to the healthcare professional is made from the pharmacy long after the professional has tended to the patient. Therefore, there may be a lapse in the current information that the professional has readily accessible regarding the patient. The professional's decision is either made with limited information or is made after a period of time for the professional to acquire the necessary patient information. However, present healthcare professionals, via a handheld device or otherwise, do not communicate in real-time with benefits managers during the authorization of a renewal and is not readily privy to recent prescription-related information retained by the benefits manager at the time of deciding to authorize a renewal prescription.

Furthermore, any formulary information that is received by a healthcare professional from a benefits manager must be analyzed by the healthcare professional through the use of software applications. Because each benefits manager may provide formulary information in a different format, the healthcare professional must have specialized software to support each benefits manager, which must be further updated when a benefits manager changes the format of the information.

In addition, with existing systems the process of transferring data between an external site and a handheld device is performed in batch off-line, where the data is processed at each segment of the network pathway according to its place in queue. Thus, delays may occur as the data waits its turn to be processed and passed through the pathway. In addition, data generated at a handheld device is usually first transferred to a computer, such as through a docking system, where the data remains until the computer picks up the data and transfers it into the network. Consequently, there presents considerable postponement in providing health services.

In general, the shortcomings of the currently available methods for performing electronic prescription transactions are inadequate to allow real-time transmission between a pharmacy site, a remote benefits manager and a handheld device. In particular, previous methods do not provide an open pipeline for a healthcare professional to obtain prescription-related information from a benefits manager during the course of transacting a prescription renewal in order to make an informed decision on the renewal request.

### BRIEF DESCRIPTION OF THE DRAWINGS

The present invention is illustrated by way of example, and not limitation, in the figures of the accompanying drawings in which:

FIGS. 1A and 1B are a block diagrams illustrating systems for prescription renewals wherein FIG. 1A shows a prior art system of conducting a renewal transaction and FIG. 1B shows one embodiment of a health information system having a user system that communicates with one or more benefits manager and pharmacy sites, in accordance with the teachings presented herein.

FIG. 2 is a block diagram example of a portable healthcare device to respond to a renewal request, in accordance with the teachings presented herein.

FIG. 3 is a block diagram example of an access server to process network communications, in accordance with the teachings presented herein.

FIG. 4 is a flow chart depicting an exemplary prescription renewal method, according to the teachings presented herein.

FIG. 5 is a block diagram showing the role of a pharmacy site, benefits manager and access server for transacting a prescription renewal, in accordance with the teachings presented herein.

FIG. 6 is a block diagram depicting the transferring of payload data across a real-time network pathway, according to teachings presented herein.

FIG. 7 is a block diagram of a machine-accessible medium storing executable code and/or other data to provide one or a combination of mechanisms to control prescription renewal transactions, in accordance with one embodiment of the present invention.

### DETAILED DESCRIPTION

The present invention provides for performing a transaction for renewing a prescription through exchange of information among a pharmacy site, benefits manager and a portable healthcare device through an end-to-end communication system that includes a real-time communication channel. A renewal request is transmitted from the pharmacy site to a benefits manager, where prescription-related information is immediately added to the request. In some embodiments, the benefits manager also adjudicates the renewal request. The combined request having the prescription-related information is sent to an access server of a user system for reading at the portable healthcare device. Through the portable healthcare device, a healthcare professional considers the combined request to decide whether to approve the renewal and sends the renewal decision back to the pharmacy site. In this manner, a healthcare professional receives the renewal request and relevant information in real-time and may immediately respond in an informed manner to a pharmacy site's renewal request.

The prescription-related information that is inserted into the request by the benefits manager may include patient specific information, such as the current formulary for the patient who is the subject of the renewal request, the patient's eligibility status, the patient's prescription history, etc. The prescription-related information may also include general information on the items listed in the prescription renewal, such as costs, comparable other items, optimal dosages or amounts, potential drug interferences or other warnings, usage instructions, product promotions, etc. Usually the prescription-related information is current information that is kept substantially up-to-date. Without recent prescription-related information from a benefits manager, it is uncertain whether the requested renewal complies with a patient's present formulary or eligibility status, optimal prescription parameters, e.g. dosage amounts, usage directions and concentration, etc. Thus, the electronic prescription renewal system of the present invention assists in generating correct and desirable prescription renewals.

The user of the portable healthcare device that receives the renewal request may be any organization comprised of a health professional or individual who is a health professional, such as a healthcare provider, e.g. a provider of medical or prescription-related services. The user decides on the prescription renewal request or conveys the decision through the portable healthcare device under direction of a healthcare professional who is authorized to perform such decision-making task. There may be one or more than one user of a single portable healthcare device.

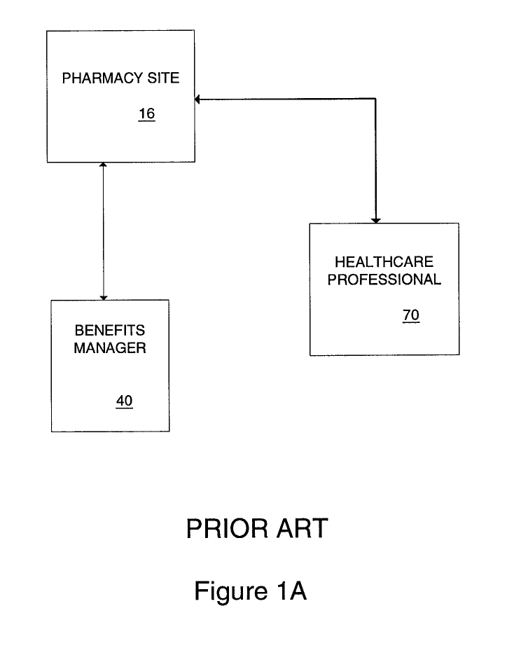

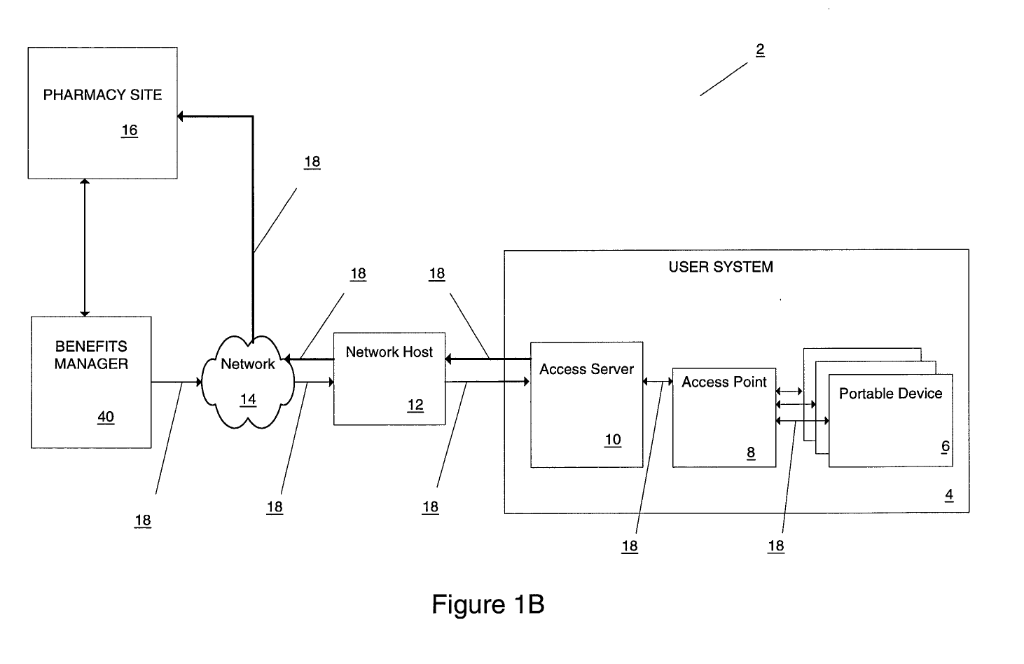

FIG. 1B illustrates an embodiment of an integrated health information system 2 according to the present invention, having various segments, e.g. pharmacy site, benefits manager, user system, etc., along a network pathway 18 to transact a prescription renewal from a pharmacy site 16. The network pathway 18 is an open network channel that provides a constant connection of the segments of the pathway so that prescription-related information may continually flow through the segments among any given pharmacy site, benefits manager and portable healthcare device. A remote pharmacy site 16 communicates with a remote benefits manager, which communicates with a network host 12 that communicates with a user system 4. In addition to communicating with the remote benefits manager 40, the user system 4 communicates with the remote pharmacy site 16 through an external network 14 and along the network pathway 18, according to the present invention. Within the user system 4, at least one portable healthcare device 6 is to communicate with an access server 10 often through one or more acess points 8 along the network pathway 18. Also, a network host 12 in the network pathway 18 serves as an intermediary between a user system and the PBM/pharmacy.

Although FIG. 1B demonstrates a particular layout of integrated health information system, the scope of the present invention also anticipates other variations of the system to provide for transfer of information related to a prescription renewal. Any number of portable healthcare devices may be in communication with any number of remote pharmacy sites and benefits managers through any number of access points, including no access points, leading to one or more access servers, which may be arranged in various fashions within the network environment. An integrated health information system may also include any number of network pathways. In one embodiment, the access server and/or network host may further be shared by various other user systems.

The user system 4, e.g. a clinic, hospital, office, etc., includes at least a wireless internal network for access to the portable healthcare device or a group of portable healthcare devices. The user system may incorporate a wireless local area network (LAN) through which the components communicate. The user system may also include a wired internal network that communicates with the wireless internal network.

Through the wireless link within the user system and via the access server 10, the portable healthcare device 6 provides for transmission and/or receipt of renewal requests, prescription-related information and responses. A health professional may use the portable healthcare device during the course of performing other daily tasks, such as caring for a patient, and simultaneously send and/or obtain renewal requests and prescription-related information “on the fly”. The portable healthcare device conveniently connects a health professional to sources outside of the user system, e.g. benefits manager and a pharmacy site, in real-time and with minimal interruption to the healthcare professional. The healthcare professional may use the portable healthcare device to receive a renewal request for a particular patient in near real-time, e.g. within a few seconds of a pharmacy site sending the request to a benefits manager. This request may also include prescription-related information retained at the benefits manger. In answer, the healthcare professional may send a renewal request response to a pharmacy site via the access server.

The portable healthcare device 6 may include a variety of devices that are easily moveable or mobile and that may receive a renewal proposal and prescription-related information and may generate and send a response, in electronic form via a network. The portable healthcare device is usually a handheld computer that is of sufficient size to be used while a person is carrying it and often to be conveniently stored in a pocket.

The portable healthcare device is an intelligent wireless device, such as a personal digital assistant (PDA), e.g. the iPAQ® Pocket PC (from Compaq Computer Corporation, located in Houston, Tex.) and Jornada® (from Hewlett-Packard Corporation, located in Palo Alto, Calif.); a wireless telephone (e.g. cellular, personal communications services (PCS), etc.), a wearable computer, a pager, a BlackBerry™ (from Research in Motion, Ltd., located in Ontario, Canada) or other wireless intelligent device that is portable and may additionally have specific components for use in the integrated health information system. The device may be a wireless, portable computer system, such as a laptop, pocket computer, such as Omnibook® (from Hewlett-Packard Corporation, located in Palo Alto, Calif.) or Powerbook® (from Apple Corporation, located in Cupertino, Calif.) The devices listed are by way of example and are not intended to limit the choice of apparatuses that are or may become available in the portable wireless communications device field that may send or receive information without the need for wires or cables to transmit information, as described herein.

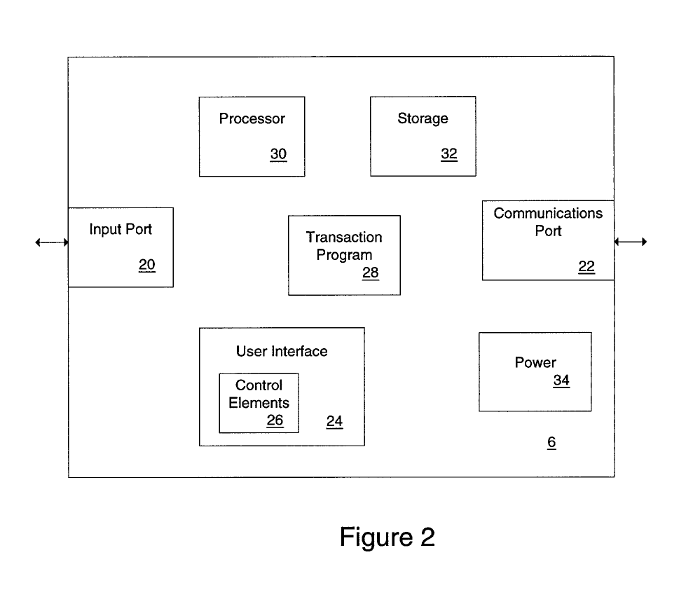

FIG. 2 depicts one embodiment of a portable healthcare device 6 having a communication port 22 to forward data to and receive data from components of the user system, e.g. the access server, access point(s) and/or other components along the network pathway. For example, the wireless communication port 22 may send a prescription proposal, prescription, or other prescription-related information into the wireless portion of the network pathway, which may be passed directly to an access server or through at least one access point that in turn transmits the information to the internal network for receipt at the access server.

The wireless communication port 22 communicates with the next receiving point, e.g. access point or access server, in the network pathway through a wireless communication segment of the pathway. The wireless communication port 22 may communicate through carrier wave transmissions, such as infrared radiation and radio frequency (RF), usually according to any of the numerous communication standards used in the telecommunication industry. A common standard protocol is the IEEE 802.11b (Institute of Electrical and Electronics Engineering, std. 802.11b, published by IEEE, September 1999), WiFi™, Bluetooth, etc. In addition, various protocols may be used by the portable healthcare device to communicate within the user system, such as a network layer (Open Systems Interconnection (OSI) standards established by the International Standards Organization (ISO).

The portable healthcare device 6 also includes an input unit 20 to enter a response or other prescription-related information to the portable healthcare device components to be sent to an access server. In some cases, the prescription-related information entering the system may be in a raw format, such as voice data. This raw format data may require further processing by the portable healthcare device, access server or other component of the user system. In other cases, the data is in a format that is useable by an access server, benefits manager, and/or remote pharmacy site.

The input port may be coupled to a user interface 24 for presenting to the user a renewal request of a pharmacy site, prescription-related information regarding the request from a benefits manager, and/or a response that arrives or departs, such as on a display screen. In other embodiments, the input port may directly connect to an information source. The presentation of prescription-related information on the user interface may be of assistance to the user in generating a prescription. The user interface 24 may be a visual interface, e.g. display; an audio interface, e.g. microphone, speaker, etc.; and/or a kinesthetic interface e.g. contact sensitive surface, deformable surface, etc. The user interface may include one or more control elements 26 to generate prescription-related information.

There are various types of control elements that may be include in the user interface. One type of control element is visible through a display screen type user interface, e.g. a liquid crystal display, which may be integrated with the portable healthcare device or coupled to the device. Such control elements may include buttons, pop-up or pull-down menus, scroll bars, iconic images, and text entry fields. The visual control elements may be activated by a variety of mechanisms, such as a touch pad screen, pen-to-text data entry device, or activation mechanisms present on input/output devices, such as a keyboard and/or a mouse. Other control elements may be invisible to a display, such as voice or audio recognition elements, optical recognition elements, touch responsive elements, etc. There are a variety of interactive mechanisms to activate invisible and/or visible controls, such as voice or audio commands, touch movement or imprints, network signals, preprogrammed triggers within the system, instructional input from other applications, etc.

The renewal request response may include an approval of the renewal or decline of the renewal. In some cases, the response may include a notice that additional information is required for the requested renewal transaction to be completed. Where prescription-related information includes at least one suggested alternative parameter, such as some other prescription item, amount, concentration, usage instruction, etc, the response may include a conditional approval that the pharmacy site revise the renewal to incorporate one or more of the suggested alternatives.

One or more prescription renewal transaction software program(s) 28 may provide prompts for the user to input through the user interface desired renewal response parameters, and the like. The renewal software program may also provide prompts for the user to submit patient information related to renewal. In one situation, the transaction program may provide a list of options that may be included in a renewal response from which the user may chose. In another embodiment, the renewal software program considers the prescription-related information from the benefits manager and automatically decides whether to accept or deny the renewal in response. For example, where the prescription-related information includes ineligibility of a patient, the program may return a declined renewal response.

In still another case of renewal software program, adjudication results received from a benefits manager may be considered to determine an appropriate renewal response. The program may adjust renewal parameters according to the adjudication results, including any suggested alternatives, and the response sent to back to the pharmacy site may include such adjustment. For example, where the proposal is declined by a benefits manager and at least one alternative is recommended by the benefits manager, the software program may automatically integrate one of the alternatives into the renewal and present the alternatives to the user for selection.

The software program is suitable to read information that has been prepared by an access server. Usually, the portable healthcare device need not employ specialized software programs, for each format of adjudication communications sent from different benefits managers. In general, the portable healthcare device may deliver numerous prescription-related transactions through various software programs, such as TouchWorks™ (from Allscripts Healthcare Solutions, located in Illinois).

The portable healthcare device 6 also includes processor 30, which may represent one or more processors to run an operating system and applications software that controls the operation of other device components. Some processors are an Intel StrongARM®, a Motorola® Power PC processor, etc.

A storage unit 32 is provided to hold data related to specific prescription-related information, one or more option menu(s) for display to the user through the user interface, prescription-related information and/or other transaction-related data. The storage unit 32 may be any electric, magnetic, optical, magneto-optical, and/or other type of machine-readable medium or device for writing and storing data. For example, the storage unit 32 may be a magnetic disc, random access memory (RAM), such as dynamic RAM (DRAM) and static Ram (SRAM), etc. The amount of storage required depends on the type and amount of data stored.

Often a non-volatile storage, e.g. Flash memory, or cache, is provided for the operating system and resident software applications. The storage unit may also be a hard drive, either integrated within the system, or external and coupled to the system. The storage unit may also be coupled to other types of multiple storage areas that may be considered as part of the storage unit or separate from the storage unit. These storage units 32 described are by way of example and are not intended to limit the choice of storage that are or may become available in the data storage field, as described herein.

A power unit 34 is included with the portable healthcare device to supply energy used to operate the device components. In one embodiment, the power unit 34 may be an energy storage area to hold power, which may be integrated into the device or removable and capable of being inserted into the device. For example, the power unit 34 may be a battery that is charged by energy from an external source. In another embodiment, the power unit 34 may be simply a power connector to direct energy from an external power source to the various device components rather than to store energy.

Furthermore, the portable healthcare device may also have various optional components, such as a biometric data reader or other security measures to ensure permitted access to the internal network, protect transferred data, and the like. Security may be provided through encryption and/or authorization tools.

The transmission entering into and exiting from the portable healthcare device may pass through one or more access point(s) 8, e.g. wireless access point(s), that serve as a bridge between the access server and/or an existing wired network and the wireless device. The access point may also act as a router to pass along transmissions from one access point to another.

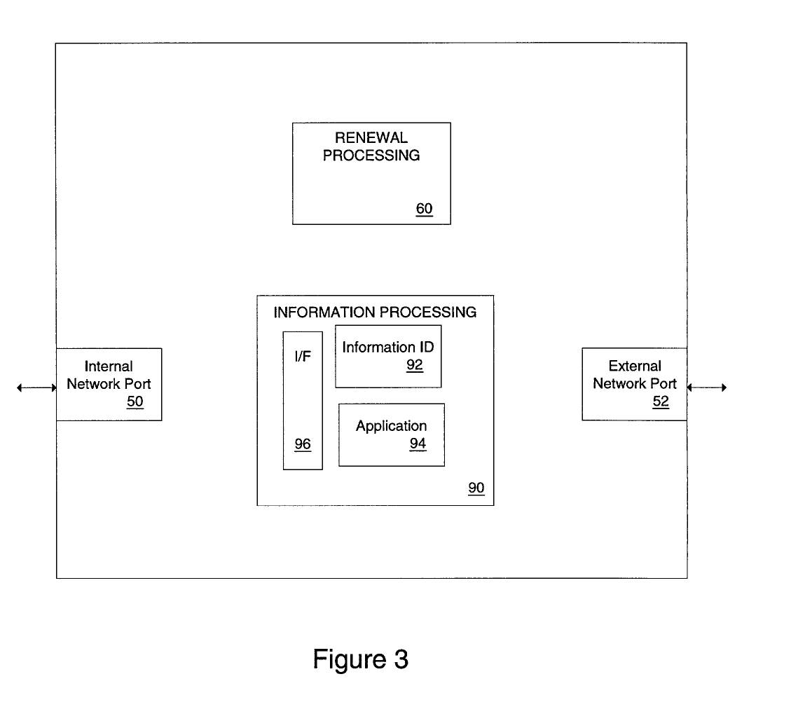

The access server functions as an interface for all communications leaving and entering the user system to conduct any necessary processing and translations on the transmissions. One embodiment of access server 8 in the user system is shown in FIG. 3. An internal network port 50 receives communication, e.g. renewal response promulgated from the portable healthcare device, of the internal network of the user system. Furthermore, the access server has an external network port 52 to transport a response to the renewal request from the portable healthcare device into the network pathway to the pharmacy site. The external network port 52 is also to accept communications, e.g. a renewal request of a pharmacy site including prescription-related information of a benefits manager, from the benefits manager in-real time across a network pathway.

The access server also includes a renewal processing unit 60 to prepare the renewal request, prescription-related information, which may include adjudication results, received from the pharmacy site via the benefits manager. The results are formatted for reading at the portable healthcare device. Thus, the portable healthcare device need not carry application programs for each format of information used by various benefits managers. In one embodiment, the renewal processing unit 60 may be also process the prescription renewal request by applying at least one predefined rule to process the prescription renewal, such as rules concerning billing-related rules, other business rules, etc.

In addition, an information processing unit 90 may be provided for processing information, e.g. response, renewal request, prescription-related information, that is to be sent through the network pathway and/or received from the network. An information identification unit 92 may be included to determine what type of information is received. Furthermore, a server interface 96 is for preparing the information to be in a suitable format for the next segment of the network pathway to receive the information.

The identification unit 92 may determine to where the information should be transferred. Such a determination may be made by referencing an original request for the prescription-related information or as specified in the transmission unit. The receiving destination may be a requesting portable healthcare device, some other portable healthcare device, a designated electronic device or computer, a network host, an access point, a remote pharmacy site, a next segment toward a particular second end of the network, etc. In one embodiment, the information identification unit 92 may recognize the received information as a response to an earlier requested renewal transaction or as a new renewal transaction. For instance, the access server may maintain a log of references to received renewal requests and the identification unit compares the incoming request with the prior requests, such as where additional information was required for the healthcare professional to determine whether to accept a renewal. In addition, an incoming response from a portable healthcare device may be compared with the references in the log of currently pending renewal requests to determine the pharmacy site that originated the request.

Furthermore, the access server 8 may include an application unit 94 to determine the software application program to which the information belongs to and how the information should be entered into the appropriate application. The information may be associated with an application that is specific for the remote pharmacy site that sent it or multiple remote sites may be supported by one application program.

The access server usually also includes some conventional server components as known in the field. For example, a processor for controlling the other server components, and a storage unit for storing programs, data, bus(es), etc. may be provided.

In still other embodiments of an access server, various other optional components may be present in the access server, which assist in transfer of information. The access server may have a back-end processing unit for providing back-end services or support for a front-end application running on a portable healthcare device or other component of the user system. Such back-end processing unit may process raw response and/or other prescription-related information generated by the portable healthcare device. For example, a speech recognition engine may be included to convert speech data collected by the portable healthcare device.

The user system is also coupled to a network host 12 in order for the user system to maintain a connection with a network to the benefits manager and remote pharmacy site. The network host is the hub for all communications traveling to and/or from a user system and external network 14.

The external network 14 is a public network, e.g. the Internet, or, e.g. dedicated leased communication line, which may only be used by one user system and remote pharmacy site. Usually, the network provides for security in transport, as in a VPN where special encryption is used at the sending end and decryption at the receiving end. The external network is a constant on-line channel between the remote pharmacy site and network host, such that the user system or remote pharmacy site may communicate with each other at any time.

The transfer of renewal requests, prescription-related information and responses from across the network pathway is in real-time from the time the information leaves one end of the pathway, e.g. the pharmacy site or the portable healthcare device, and reaches its destination end, e.g. the pharmacy site or the portable healthcare device.

One or more remote pharmacy site 16 may send a prescription renewal request or other prescription-related information, in electronic form into the respective network pathway and optionally receive communications, such as responses from various components of the user system. The remote pharmacy site fills the renewal prescription upon receiving the appropriate approval. Oftentimes, the remote pharmacy site is a pharmacy, including retail, online or mail order pharmacy that supplies a patient with the prescribed item, that may be picked up by or delivered to the patient. Usually, the health information system includes a variety of remote pharmacy sites connected to the network pathway, which may be of different types.

Benefits manager 40 communicates with the pharmacy site 16 and network host 12. The benefits manager 40 is remotely located from the network host 12. The pharmacy is connected to the network host via an Internet connection. The pharmacy is connected via leased line to the PBM. The PBM is connected to the network host via a network connection (e.g. virtual private network, VPN). In one embodiment, the benefits manager is able to locate and add the appropriate prescription-related information for a renewal request and/or adjudicate a prescription proposal “on the fly” and provide results to the access server in seconds upon receiving the renewal request. A network connection between the benefits manager and the other network segments may be a public network, e.g. the Internet, semi-public network that provides for tunneling of data packets, e.g. a virtual private network (VPN), or private network, e.g. dedicated leased communication line. Security is provided through protocols used to encrypt the data.

Often, the benefits manager is a private firm that contracts with health plans or plan sponsors and specialize in claims processing and administrative functions involved with operating a prescription drug program. The benefits manager tracks prescription related information for a patient. Examples of the patient prescription related information that a benefits manager may store includes patient eligibility into a particular health plan according to an insurance company, formulary for the patient, prescription history and patient's fill record for those prescriptions, etc. The benefits manager may also have other prescription related information that are not specific for a patient, such as comparable items that may be prescribed and their costs, e.g. generic drug versions. Where the benefits manager adjudicates the renewal request, one or more of this prescription-related information may be considered for a benefits manager during adjudication to assess a request.

In one embodiment, the benefits manager combines the adjudication results into the renewal request and sends it to the user system. The adjudication results may include an approval that the renewal request has cleared the benefits manager requirements and the healthcare professional may continue make the final decision to approve or decline the renewal, or a negative answer that the proposal is declined by the benefits manager as presently written and must be rewritten in order to carry out the transaction. Where adjudication results includes a decline of permission from the benefits manager the renewal request may be bounced back to the originating pharmacy site and not transmitted to the user system or simply forwarded along with the adjudication results to the user system for further consideration by the healthcare professional.

At times, the prescription-related information includes suggested alternative parameters. In this case, alternatives may be coupled to a declined proposal and the alternatives may be substituted to generate an acceptable prescription renewal. In the alternative, the alternatives may be included in an accepted renewal adjudication result and the alternatives are mere suggestions on forming an even more desirable prescription renewal. In still another embodiment, the adjudication results include the raw patient data stored at the benefits manager. In this embodiment employing raw data results, the access server may consider the data to automatically determine whether a prescription renewal is acceptable to be transacted or withhold permission based on the adjudication results provided from the benefits manager.

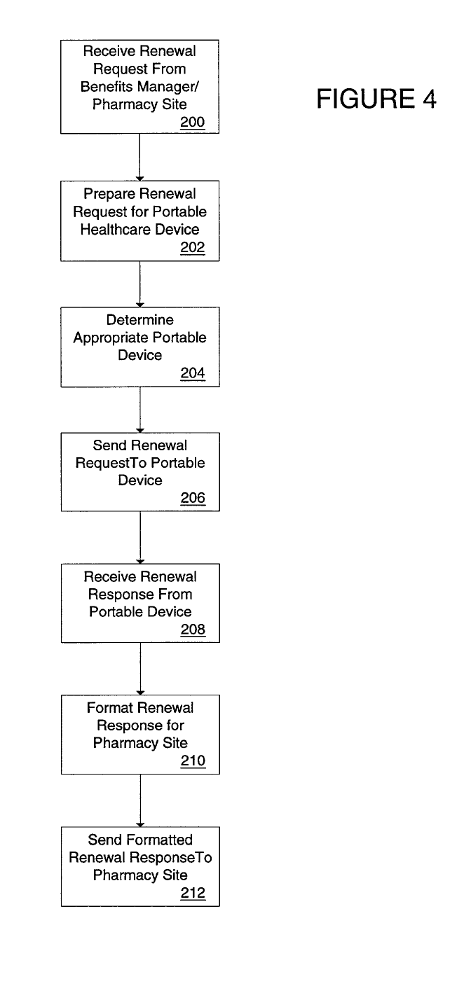

FIG. 4 shows one embodiment of a process to adjudicate a prescription proposal for a prescription transaction, according to the present invention. A renewal request is received from a portable healthcare device of the pathway 200. The preparation may include formatting the results so that it may be readable by a portable healthcare device without special translation software applicable to a benefits manager 202. Preparation may also entail integrating the results to the matching prescription proposal.

The appropriate portable healthcare device to receive the request is determined, usually by searching a device database that lists healthcare professionals for each device 204. This database may also store previous prescriptions generated by the professional or patients tended to by the professional The appropriate device is associated with a healthcare professional or other user responsible for deciding whether a renewal should be approved or not. Oftentimes, the healthcare professional had previously originated the prescription that is requested to be renewed. Where a patient had switched to another healthcare professional for service, the database may include a reference to the currently responsible professional. The renewal request is sent to the appropriate portable healthcare device through a network channel 206.

When a response to the renewal request is received from the portable healthcare device 208, the response is formatted according to the requirements for the particular pharmacy site that is to receive the response 210. Usually, the response is sent 212 to the pharmacy site that had originated the request for the renewal, although in some cases, one pharmacy site may direct the response to be sent to some other specified pharmacy site. The pharmacy site completes the renewal transaction. At times, response is a requirement for additional information or a change in the renewal parameters, in which case, a new renewal request may be sent by pharmacy site and the process repeats from the receiving of the proposal 200.

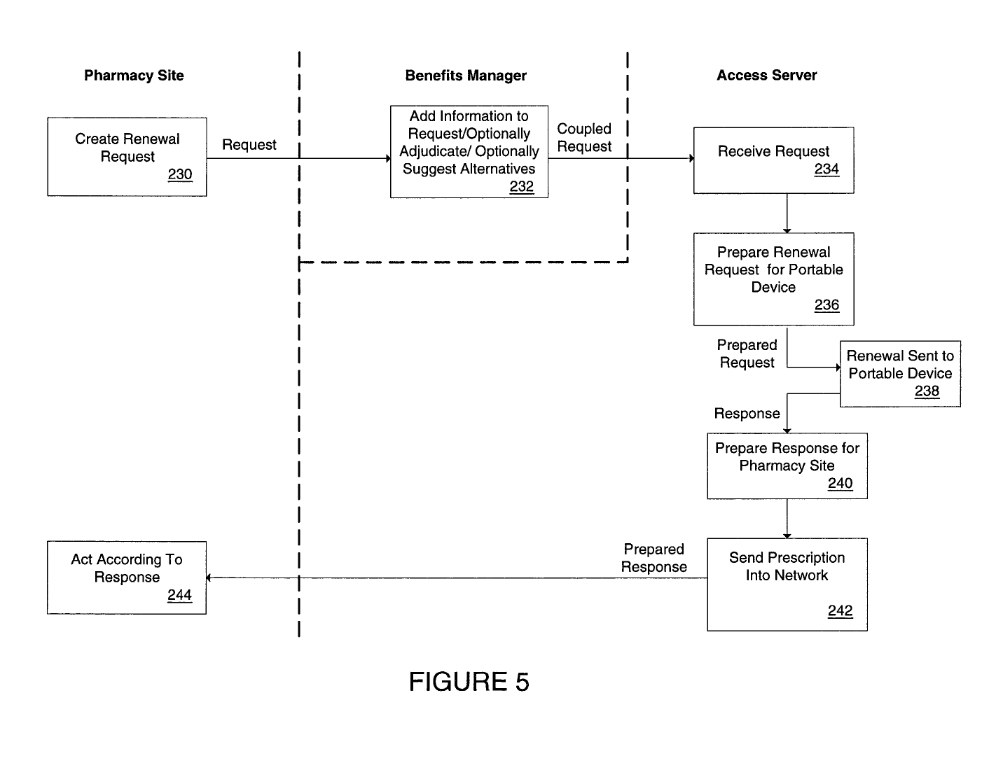

The prescription transaction occurs through interactions of a portable healthcare device, access server, benefits manager and remote pharmacy site of the integrated health system, as shown by one embodiment in FIG. 5. The pharmacy creates a prescription renewal request 230 and transfers the request to the benefits manager via a network pathway. The renewal request is usually generated because a patient or other healthcare professional desires to have a prescription filled that does not authorize such prescription fulfillment. The benefits manager receives the request and immediately locates and couples to the request relevant prescription-related information 232. In addition, the benefits manager may optionally adjudicate the renewal request and/or suggest alternatives to the renewal parameters. The suggested alternatives may recommend other drugs, medical devices, and the like; other concentrations or amounts; other directions for use; promotional notices, etc.

The access server receives the request processes the renewal request 234 and processes the request such that the request is readable by the portable healthcare device 236. The access server transfers the prepared renewal request to the appropriate portable healthcare device 238. When a response is received back from the portable healthcare device, the response is prepared for reading at the pharmacy site 240. The prepared response is transferred to the pharmacy site 242, where the response is considered, including any suggested alternatives.

The pharmacy site acts according to the to site satisfy the transaction 244. For example, the pharmacy site may refill the prescription where the response to the renewal includes an approval or refuse to refill if the response includes a decline. In addition, if the response includes suggested alternatives, the pharmacy may refill the prescription according to the new instructions from the healthcare professional. In the alternative, the pharmacy site may change the renewal request according to the suggestions and resubmit the request.

From the time a pharmacy site requests a renewal transaction, the action by the benefits manager is usually swiftly performed and the healthcare professional rapidly receives the request. In addition, as soon as the portable healthcare device submits a response, the information promptly flows through the segments of the network pathway to be received by the pharmacy site. All steps of the process may be instantly performed to achieve fast turn-around times, e.g. within a few seconds of time, performance of the prescription renewal transaction, i.e. in real-time.

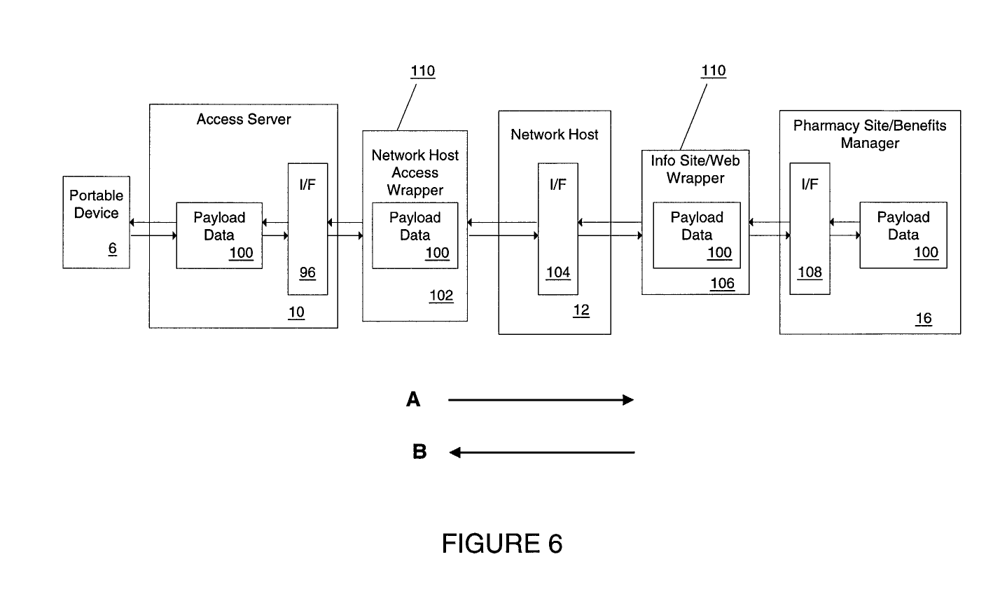

FIG. 6 depicts a network pathway with a global infrastructure to enable applications on the portable healthcare device to provide real-time data or for a remote pharmacy site to push real-time content to a portable healthcare device, during a transaction. The network pathway has various segments with interfaces for communicating the prescription-related information to a next sequential segment in the pathway. Segments may include an access server, network host, remote pharmacy site, benefits manager or other intermediary apparatus along the network pathway that intercepts and/or sends the information.

In conducting a transaction, prescription-related information is directed through the integrated health system as a payload data 100 in a transmission unit 110, e.g. packet, that starts at either end of the pathway, i.e. the portable healthcare device 6, benefits manager or remote pharmacy site 16. A body of information, e.g. renewal request, prescription-related information and/or renewal response, that is to be transferred through the system is packed into a single transmission unit, or more usually, a stream of multiple transmission units. The interfaces prepare the transmission unit for the next segment and, in most cases, do not alter the information as released from the first end of the pathway. Some embodiments of a network pathway provides for bi-directional transfer of information between the two ends of the pathway. Where the transmission of the information is initiated from the portable healthcare device, i.e. first end, to the remote pharmacy site, i.e. second end, the transmission units travel in a direction A, and where the communication of the information occurs initially from the remote pharmacy site, i.e. first end, towards the portable healthcare device, i.e. second end, the transmission units move in a direction B.

In the cases that the prescription-related information is sent in direction A, the information flows through a server interface 96 of an access server 10. The server interface 96 places the payload data 100 in a wrapper 102 that contains the data recognizable by the next segment, such as the network host 12, in the network pathway. The network host 12 has a host interface 104 that prepares the payload data for reading by a benefits manager and/or remote pharmacy site and sends the information into the network 14. Usually, the host interface envelopes the payload data with a remote pharmacy site or benefits manager wrapper 106 having data, e.g. header information, acceptable by the remote pharmacy site or benefits manager. The host interface may remove any present wrappers 102 and provide a new wrapper 106 specific for the remote pharmacy site or benefits manager to receive the information. Oftentimes, each remote pharmacy site requires different proprietary wrapper information. Upon receipt of the transmission unit by the remote pharmacy site, the remote pharmacy site or benefits manager interface 108 removes the wrapper 106 to reveal the payload data 100.

Where the information is moved through the network pathway in the direction B, the remote pharmacy site/benefits manager interface 106 prepares payload data 100 for sending into the network by placing the payload data into a wrapper 106 for web host access. The network host 12 intercepts the transmission unit and passes the unit through a host interface 104 that prepares the payload data for reading by the access server. The payload is placed in a wrapper 102 specific for the access server. The server interface 96 of the access server 10 strips away the wrapper 102 to reveal the payload data. The portable healthcare device receives the information and usually immediately presents it to a user.

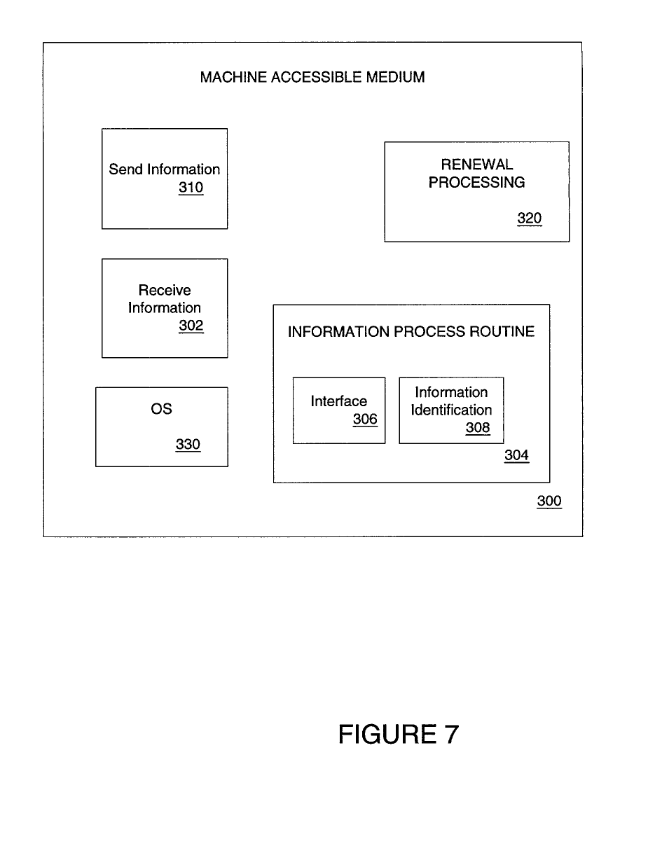

Various software components, e.g. applications programs, may be provided within or in communication with the access server that cause the processor or other components of the server to execute the numerous methods employed in conveying information through a network pathway. FIG. 7 is a block diagram of a machine-accessible medium storing executable code and/or other data to provide one or a combination of mechanisms for transacting a prescription renewal with adjudication, according to one embodiment of the invention.

The machine-accessible storage medium 300 represents one or a combination of various types of media/devices for storing machine-readable data, which may include machine-executable code or routines. As such, the machine-accessible storage medium 300 could include, but is not limited to one or a combination of a magnetic storage space, magneto-optical storage, tape, optical storage, battery backed dynamic random access memory, battery backed static RAM, flash memory, etc. Various subroutines may also be provided. These subroutines may be parts of main routines in the form of static libraries, dynamic libraries, system device drivers or system services. The processes of various subroutines, which when executed, are described above with regard to FIG. 4.

The machine-readable storage medium 300 is shown having a receive information routine 302, which, when executed, obtains a renewal response, and/or other prescription-related information from across a network.

During a transaction, incoming renewal requests and prescription-related information may be immediately passed to a result processing routine 320 for processing where such a request is received from a benefits manager. In addition, a prescription routine 322 may be employed to conduct any necessary processing of a prescription prior to sending into the network pathway.

An information processing routine 304 is for processing the received other information, such as a response from the portable healthcare device, through various subroutines. An interface subroutine 306 is for preparing the information with appropriate data for reading at the next segment. An information identification subroutine 308 may be executed for identifying the information and/or determining the appropriate next segment to receive the information. A send information routine 310 includes instructions for sending the processed information, in the form of transmission unit(s) into the network towards its ultimate destination.

In addition, other software components may be included, such as an operating system 330.

When the instructions are executed, they cause a processor to perform the steps as described. For example, the instructions may cause a processor accept information, process the information, forward the information, etc.

The present invention has been described above in varied detail by reference to particular embodiments and figures. However, these specifics should not be construed as limitations on the scope of the invention, but merely as illustrations of some of the presently preferred embodiments. It is to be further understood that other modifications or substitutions may be made to the described integrated health information system as well as methods of its use without departing from the broad scope of the invention. The above-described steps of transacting prescription renewals through a real-time healthcare network pathway may be performed in various orders where requests are coupled to prescription-related information. Therefore, the following claims and their legal equivalents should determine the scope of the invention.

What is claimed is:

1. A method of a conducting prescription renewal transaction, the method comprising:
receiving a renewal request of a pharmacy site from a benefits manager in-real time across a network pathway, the renewal request including prescription-related information of the benefits manager;
transmitting the renewal request to a portable healthcare device to response to the renewal request; and
sending the response into the network pathway to the pharmacy site to fill the renewal.

2. The method of claim 1, wherein the prescription-related information includes patient formulary, eligibility status, prescription history, item cost, at least one alternative parameter or potential drug interferences.

3. The method of claim 2, wherein the response includes acceptance conditional on incorporating at least one of the alternative parameter.

4. The method of claim 1, wherein the response is an approval or decline of the renewal.

5. The method of claim 1, wherein the renewal request includes adjudication results from the benefits manager.

6. The method of claim 5, wherein the adjudication results includes an approval or decline from the benefits manager of the renewal request.

7. The method of claim 1, further including preparing the renewal request from the benefits manager to read at the portable healthcare device prior to the transmitting of the renewal request.

8. The method of claim 1, further including preparing the response from the portable healthcare device to read at the pharmacy site prior to the sending of the response.

9. A system to transact a prescription renewal, comprising:
a) an external network port to receive a renewal request of a pharmacy site including prescription-related information of a benefits manager, from the benefits manager in-real time across a network pathway;
b) a renewal processing unit to prepare the renewal request received from a benefits manager for reading at a portable healthcare device; and
c) an internal network port to send the prepared renewal request to the portable healthcare device for response,
the external network port further to transfer the response to the renewal request from the portable healthcare device into the network pathway to the pharmacy site.

10. The system of claim 9, wherein the prescription-related information includes patient formulary, eligibility status, prescription history, item cost, comparable alternative parameter, optimal amount or potential drug interferences.

11. The method of claim 10, wherein the response includes acceptance conditional on incorporating at least one of the alternative parameter.

12. The system of claim 9, wherein the response is an approval or decline of the renewal.

13. The system of claim 9, wherein the wherein the renewal request includes adjudication results from the benefits manager.

14. The system of claim 13, wherein the adjudication results includes an approval or decline of the renewal request.

15. The system of claim 9, further including an interface to prepare a response from the portable healthcare device for reading at the pharmacy site,

16. A computer accessible medium having stored therein a plurality of sequences of executable instructions, which, when executed by a processor, cause the system to:
receive a renewal request of a pharmacy site from a benefits manager in-real time across a network pathway, the renewal request including prescription-related information of the benefits manager;
transmit the renewal request to a portable healthcare device to response to the renewal request; and
send the response into the network pathway to the pharmacy site to fill the renewal.

17. The computer accessible medium of claim 16, wherein the prescription-related information includes patient formulary, eligibility status, prescription history, item cost, alternative parameter or potential drug interferences.

18. The method of claim 17, wherein the response includes acceptance conditional on incorporating at least one of the alternative parameter.

19. The computer accessible medium of claim 16, wherein the response is an approval or decline of the renewal.

20. The computer accessible medium of claim 16, wherein the renewal request includes adjudication results from the benefits manager.

21. The computer accessible medium of claim 16, wherein the adjudication results includes an approval or decline of the renewal request.

22. The computer accessible medium of claim 16, wherein the adjudication results includes at least one suggested alternative parameter.

23. The computer accessible medium of claim 16, further including preparing the renewal request from the benefits manager for reading at the portable healthcare device prior to the transmitting of the renewal request.

24. The computer accessible medium of claim 16, further including preparing the response from the portable healthcare device for reading at the pharmacy site prior to the sending of the response.

25. A method of verifying a user in a prescription-related transaction, the method comprising:
receiving a renewal request of a pharmacy site from a benefits manager in-real time across a network pathway, the renewal request including prescription-related information of the benefits manager;
preparing the renewal request from the benefits manager to read at the portable healthcare device prior to the transmitting of the renewal request;
transmitting the renewal request to a portable healthcare device to response to the renewal request;
preparing the response from the portable healthcare device to read at the pharmacy site prior to the sending of the response; and
sending the response into the network pathway to the pharmacy site to fill the renewal.

26. The method of claim 25, wherein the prescription-related information includes patient formulary, eligibility status, prescription history, item cost, alternative parameter or potential drug interferences.

27. The method of claim 26, wherein the response includes acceptance conditional on incorporating at least one of the alternative parameter.

28. The method of claim 25, wherein the response is an approval or decline of the renewal.

29. The method of claim 25, wherein the renewal request includes adjudication results from the benefits manager.

30. The method of claim 25, wherein the adjudication results includes an approval or decline of the renewal request.
